(19) United States
(12) Patent Application Publication
(10) Pub. No.: US 2023/0387473 A1
(43) Pub. Date: Nov. 30, 2023

(54) BATTERY AND METHOD FOR MANUFACTURING BATTERY

(71) Applicant: Panasonic Intellectual Property Management Co., Ltd., Osaka (JP)

(72) Inventors: Kazuyoshi HONDA, Osaka (JP); Akira KAWASE, Osaka (JP); Eiichi KOGA, Osaka (JP); Koichi HIRANO, Osaka (JP); Kazuhiro MORIOKA, Osaka (JP); Kouji NISHIDA, Osaka (JP)

(21) Appl. No.: 18/446,261

(22) Filed: Aug. 8, 2023

Related U.S. Application Data
(63) Continuation of application No. PCT/JP2021/047816, filed on Dec. 23, 2021.

(30) Foreign Application Priority Data
Feb. 15, 2021 (JP) 2021-021981

(51) Int. Cl. H01M 10/0585; H01M 50/54; H01M 50/533; H01M 50/543; H01M 10/052

(52) U.S. Cl. CPC H01M 10/0585; H01M 50/54; H01M 50/533; H01M 50/543; H01M 10/052

(57) ABSTRACT

A battery includes a power generation element that includes a plurality of unit cells each including a positive electrode layer, a negative electrode layer, and a solid electrolyte layer, the unit cells are stacked in a direction normal to a main surface, in a side surface of the power generation element, one electrode layer of the positive electrode layer and the negative electrode layer in each of the unit cells protrudes more than the other electrode layer such that depressions and projections are provided, each of the depressions includes a first inclination surface that is an end surface of the other electrode layer, and the battery further includes: one or more conductive members in contact with a corresponding one of the projections; an insulating member that covers the side surface; and one or more extraction electrodes that are in contact with the one or more conductive members.

### CROSS REFERENCE TO RELATED APPLICATIONS

This is a continuation application of PCT International Application No. PCT/JP2021/047816 filed on Dec. 23, 2021, designating the United States of America, which is based on and claims priority of Japanese Patent Application No. 2021-021981 filed on Feb. 15, 2021. The entire disclosures of the above-identified applications, including the specifications, drawings and claims are incorporated herein by reference in their entirety.

### FIELD

The present disclosure relates to batteries and methods for manufacturing batteries.

### BACKGROUND

Conventionally, batteries in which current collectors and active material layers are stacked are known (see, for example, Patent Literatures (PTLs) 1 to 3). For example, PTL 1 discloses a secondary battery in which a plurality of units each including a current collector serving as a positive electrode, a separator, and a current collector serving as a negative electrode are stacked.

### CITATION LIST

### Patent Literature

PTL 1: Japanese Unexamined Patent Application Publication No. 2015-233003
PTL 2: Japanese Unexamined Patent Application Publication No. 2009-16188
PTL 3: International Publication No. 2019/039412

### SUMMARY

### Technical Problem

When unit cells are stacked to be electrically connected in series, in order to suppress overcharging or overdischarging in each of the unit cells to enhance the reliability of a battery, it is required to monitor a voltage in each of the unit cells. In order to monitor the voltage, it is necessary to connect an extraction electrode for monitoring to each of the unit cells.

On the other hand, in order to increase the capacity density of a battery, it is required to reduce the thickness of a unit cell. However, as the thickness of the unit cell becomes smaller, a short circuit is more likely to occur at the end surface of the unit cell, and thus the reliability of the battery is impaired.

Hence, the present disclosure provides a battery which can achieve both a high capacity density and high reliability and a method for manufacturing a battery.

### Solution to Problem

A battery according to an aspect of the present disclosure includes: a power generation element that includes a plurality of unit cells each including a positive electrode layer, a negative electrode layer, and a solid electrolyte layer located between the positive electrode layer and the negative electrode layer, the plurality of unit cells are electrically connected in series and are stacked in a direction normal to a main surface of the power generation element, the power generation element includes a side surface, in the side surface, one electrode layer of the positive electrode layer and the negative electrode layer in each of the plurality of unit cells protrudes more than an other electrode layer such that depressions and projections arranged alternately in the direction normal to the main surface are provided, each of the depressions includes a first inclination surface that is inclined relative to the direction normal to the main surface and is an end surface of the other electrode layer, and the battery further includes: one or more conductive members each provided for and in contact with a corresponding one of the projections; an insulating member that covers the side surface to expose at least a part of each of the one or more conductive members; and one or more extraction electrodes that are in contact with the one or more conductive members exposed from an outer surface of the insulating member and are arranged along the outer surface of the insulating member.

A method for manufacturing a battery according to an aspect of the present disclosure includes: preparing a plurality of unit cells each including a positive electrode layer, a negative electrode layer, and a solid electrolyte layer located between the positive electrode layer and the negative electrode layer, in each of the plurality of unit cells, an inclination surface that is inclined relative to a direction normal to a main surface is provided in an end surface of an other electrode layer of the positive electrode layer and the negative electrode layer such that one electrode layer of the positive electrode layer and the negative electrode layer protrudes more than the other electrode layer, and the method for manufacturing a battery further includes: stacking the plurality of unit cells in the direction normal to the main surface by causing the positive electrode layer and the negative electrode layer to face each other; arranging, for respective one electrode layers each being the one electrode layer, one or more conductive members that make contact with protruding parts of the one electrode layers; arranging an insulating member to expose at least a part of the one or more conductive members; and arranging one or more extraction electrodes that correspond to the respective one or more conductive members and make contact with the one or more conductive members exposed from an outer surface of the insulating member and the outer surface of the insulating member.

### Advantageous Effects

In a battery according to the present disclosure, it is possible to achieve both a high capacity density and high reliability.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a cross-sectional view showing a cross-sectional configuration of a battery according to Embodiment 1.

FIG. 2 is a side view of the battery according to Embodiment 1.

FIG. 3 is a plan view of the power generation element of the battery according to Embodiment 1.

FIG. 4A is a cross-sectional view showing a cross-sectional structure of a unit cell included in the power generation element in Embodiment 1.

FIG. 4B is a cross-sectional view showing a cross-sectional structure of a unit cell included in a power generation element in a variation of Embodiment 1.

FIG. 5A is a cross-sectional view of the power generation element in Embodiment 1.

FIG. 5B is a cross-sectional view of a power generation element in the variation of Embodiment 1.

FIG. 6A is a cross-sectional view showing a cross-sectional configuration of the battery after a step of arranging conductive members in a method for manufacturing the battery according to Embodiment 1.

FIG. 6B is a side view of the battery shown in FIG. 6A.

FIG. 7A is a cross-sectional view showing a cross-sectional configuration of the battery after a step of arranging an insulating member in the method for manufacturing the battery according to Embodiment 1.

FIG. 7B is a side view of the battery shown in FIG. 7A.

FIG. 8A is a flowchart showing an example of the method for manufacturing the battery according to Embodiment 1.

FIG. 8B is a flowchart showing another example of the method for manufacturing the battery according to Embodiment 1.

FIG. 9 is a cross-sectional view showing a cross-sectional configuration of a battery according to Embodiment 2.

FIG. 10A is a flowchart showing an example of a method for manufacturing the battery according to Embodiment 2.

FIG. 10B is a flowchart showing another example of the method for manufacturing the battery according to Embodiment 2.

FIG. 11 is a cross-sectional view showing a cross-sectional configuration of a battery according to Embodiment 3.

FIG. 12 is a cross-sectional view showing a cross-sectional configuration of a battery according to Embodiment 4.

FIG. 13A is a cross-sectional view showing a cross-sectional configuration of a battery according to Embodiment 5.

FIG. 13B is a side view of the battery according to Embodiment 5.

### DESCRIPTION OF EMBODIMENTS

### Outline of Present Disclosure

A battery according to an aspect of the present disclosure includes: a power generation element that includes a plurality of unit cells each including a positive electrode layer, a negative electrode layer, and a solid electrolyte layer located between the positive electrode layer and the negative electrode layer, the plurality of unit cells are electrically connected in series and are stacked in a direction normal to a main surface of the power generation element, the power generation element includes a side surface, in the side surface, one electrode layer of the positive electrode layer and the negative electrode layer in each of the plurality of unit cells protrudes more than an other electrode layer such that depressions and projections arranged alternately in the direction normal to the main surface are provided, each of the depressions includes a first inclination surface that is inclined relative to the direction normal to the main surface and is an end surface of the other electrode layer, and the battery further includes: one or more conductive members each provided for and in contact with a corresponding one of the projections; an insulating member that covers the side surface to expose at least a part of each of the one or more conductive members; and one or more extraction electrodes that are in contact with the one or more conductive members exposed from an outer surface of the insulating member and are arranged along the outer surface of the insulating member.

In this way, the end surface of the one electrode layer of the positive electrode layer and the negative electrode layer is the inclination surface, and thus in the side surface of the power generation element serving as the multilayer of the unit cells, the other electrode layer of the positive electrode layer and the negative electrode layer can be caused to protrude. The conductive member is provided on a protruding part, and thus the conductive member can be electrically connected to the extraction electrode for monitoring the voltage (also referred to as an intermediate voltage) of the unit cell. Hence, the voltage of the unit cell can be monitored, and thus it is possible to suppress overcharging or overdischarging. The insulating member is arranged around the conductive member, and thus it is possible to suppress the occurrence of a short circuit via the conductive member. Therefore, the thickness of the unit cell can be reduced. As compared with a case where a current collection tab is provided, it is possible to reduce the size of the extraction electrode for monitoring, and thus a capacity density can be increased. As described above, in the battery according to the present aspect, it is possible to achieve both a high capacity density and high reliability.

For example, each of the one or more conductive members may be in contact with a main surface of the one electrode layer in the corresponding one of the projections.

In this way, the contact area of the conductive member and the electrode layer can be increased, and thus it is possible to reduce contact resistance, with the result that the reliability of the electrical connection can be enhanced.

For example, the one or more conductive members may include a plurality of conductive members, the one or more extraction electrodes may include a plurality of extraction electrodes, and the plurality of conductive members do not need to overlap each other when viewed in the direction normal to the main surface.

In this way, the conductive members can be arranged separately from each other, the extraction electrodes can be arranged separately from each other, and thus it is possible to suppress the occurrence of a short circuit via the conductive members or the extraction electrodes.

For example, each of the plurality of extraction electrodes may include a side surface cover portion that extends along the direction normal to the main surface and is in an elongated shape.

In this way, the area of the outer surface of the extraction electrode can be increased, and thus the battery can be easily mounted on a substrate or the like. The accuracy of the mounting is increased, and thus the accuracy of monitoring of the voltage is increased, with the result that the reliability of the battery can be enhanced.

For example, the insulating member may continuously cover from the side surface to an end of a main surface of the power generation element, and each of the plurality of extraction electrodes may further include an end cover portion that is continuous from the side surface cover portion and overlaps the insulating member when the main surface of the power generation element is viewed in plan view.

In this way, the part of the extraction electrode is located on the side of the main surface of the power generation element, and thus the battery can be easily mounted on a substrate or the like.

For example, the battery according to the aspect of the present disclosure may further include: an electrode terminal that is provided on the main surface of the power generation element, and the end cover portion of each of the plurality of extraction electrodes and the electrode terminal may have a same height when the main surface of the power generation element is a reference surface.

In this way, the height of the electrode terminal serving as the extraction part of the positive electrode or the negative electrode of the power generation element and the height of the extraction electrode for monitoring are aligned, and thus the battery can be more easily mounted on a substrate or the like.

For example, each of the one or more extraction electrodes may be in an elongated shape that extends along a direction orthogonal to the direction normal to the main surface.

In this way, the area of the outer surface of the extraction electrode can be increased, and thus the battery can be easily mounted on a substrate or the like.

For example, the battery according to the aspect of the present disclosure may further include: an electrode terminal that is provided on each of two main surfaces of the power generation element, and two electrode terminals each being the electrode terminal and the one or more extraction electrodes may have a same height when the side surface is a reference surface.

In this way, the heights of the two electrode terminals serving as the extraction parts of the positive electrode and the negative electrode of the power generation element and the heights of the extraction electrodes are aligned, and thus the battery can be more easily mounted on a substrate or the like.

For example, each of the projections may include a second inclination surface that is inclined relative to the direction normal to the main surface and is at least a part of an end surface of the one electrode layer.

In this way, the tip end of the projection can be separated from the depression. Hence, it is possible to significantly suppress the occurrence of a short circuit between the positive electrode layer and the negative electrode layer, with the result that the reliability of the battery can be further enhanced.

For example, the first inclination surface, the second inclination surface, and a part of an end surface of the solid electrolyte layer may be flush with each other.

In this way, the tip end of the projection can be separated more distantly from the depression. Hence, it is possible to more significantly suppress the occurrence of a short circuit between the positive electrode layer and the negative electrode layer. The end surfaces of the positive electrode layer, the solid electrolyte layer, and the negative electrode layer can be collectively processed to be inclined.

For example, exposed parts of the one or more conductive members and the insulating member may be flush with each other.

In this way, no step is formed between the conductive member and the insulating member, and thus a gap is unlikely to be generated between the extraction electrode and the conductive member, with the result that they can be satisfactorily connected to each other. Hence, the accuracy of the voltage which is monitored via the extraction electrode is increased, with the result that the reliability of the battery can be further enhanced.

For example, the positive electrode layer in the unit cell may include: a positive electrode current collector; and a positive electrode active material layer that is arranged on a main surface of the positive electrode current collector on a side of the negative electrode layer, and the negative electrode layer in the unit cell may include: a negative electrode current collector; and a negative electrode active material layer that is arranged on a main surface of the negative electrode current collector on a side of the positive electrode layer.

In this way, a plurality of unit cells having the same configuration are stacked by aligning the projections, and thus it is possible to easily form, in one side surface, the power generation element of the multilayer in which one of the positive electrode layer and the negative electrode layer protrudes.

For example, the one or more extraction electrodes may be in contact with the outer surface of the insulating member.

In this way, the extraction electrode and the insulating member can be brought into close contact with each other, and thus the extraction electrode is unlikely to be detached due to an impact or the like, with the result that the reliability of the battery can be enhanced. It is also possible to contribute to a decrease in the size of the battery.

For example, each of the one or more extraction electrodes may include a multilayer structure.

In this way, each of the layers in the multilayer structure can be caused to have a different function. For example, as the innermost layer which is in contact with the conductive member, a conductive material having a low connection resistance can be utilized, and as the outermost layer, a conductive material having high durability can be used. Hence, the reliability of the battery can be enhanced.

For example, an outermost layer in the multilayer structure may be a plated layer or a solder layer.

In this way, it is possible to realize a reduction in resistance, high heat resistance, high durability or the like of the outermost layer.

For example, the battery according to the aspect of the present disclosure may further include: a sealing member that exposes a part of each of the one or more extraction electrodes and seals the power generation element.

In this way, the power generation element can be protected from external factors such as humidity and impact, and thus the reliability of the battery can be enhanced.

A method for manufacturing a battery according to an aspect of the present disclosure includes: preparing a plurality of unit cells each including a positive electrode layer, a negative electrode layer, and a solid electrolyte layer located between the positive electrode layer and the negative electrode layer, in each of the plurality of unit cells, an inclination surface that is inclined relative to a direction normal to a main surface is provided in an end surface of an other electrode layer of the positive electrode layer and the negative electrode layer such that one electrode layer of the positive electrode layer and the negative electrode layer protrudes more than the other electrode layer, and the method for manufacturing a battery further includes: stacking the plurality of unit cells in the direction normal to the main surface by causing the positive electrode layer and the negative electrode layer to face each other; arranging, for respective one electrode layers each being the one electrode layer, one or more conductive members that make contact with protruding parts of the one electrode layers; arranging an insulating member to expose at least a part of the one or more conductive members; and arranging one or more extraction electrodes that correspond to the respective one or more conductive members and make contact with the one or more conductive members exposed from an outer surface of the insulating member and the outer surface of the insulating member.

In this way, it is possible to manufacture the battery which can achieve both a high capacity density and high reliability.

Specifically, the unit cells in which at least a part of the end surfaces are the inclination surfaces are stacked, and thus the power generation element including a side surface in which one electrode layer of the positive electrode layer and the negative electrode layer protrudes can be formed. The conductive member is provided on the protruding part, and thus the unit cell can be electrically connected to the extraction electrode for monitoring. Hence, the voltage of the unit cell can be monitored, and thus it is possible to suppress overcharging or overdischarging. The insulating member is arranged around the conductive member, and thus it is possible to suppress the occurrence of a short circuit via the conductive member. Therefore, the thickness of the unit cell can be reduced. As compared with a case where a current collection tab is provided, it is possible to reduce the size of the extraction electrode for monitoring, and thus a capacity density can be increased.

For example, the arranging of the one or more conductive members may be performed after the stacking.

In this way, one or more conductive members and the insulating member can be collectively arranged in the unit cells, and thus it is possible to reduce the time required for the step.

For example, the stacking may be performed after the arranging of the one or more conductive members.

In this way, the conductive members and the insulating member can be arranged in each of the unit cells individually and accurately, and thus it is possible to more significantly suppress the occurrence of a short circuit.

For example, in the preparing, the end surface of the other electrode layer of each of the plurality of unit cells may be processed to prepare the plurality of unit cells in which the inclination surface is provided.

In this way, the inclination surface having a desired shape can be formed, and thus it is possible to adjust the amount of protrusion of the positive electrode layer or the negative electrode layer.

For example, the processing in the preparing may be performed by shear cutting, score cutting, razor cutting, ultrasonic cutting, laser cutting, jet cutting, or polishing.

In this way, the end surfaces can easily be processed.

For example, in the processing in the preparing, an end surface of the negative electrode layer, an end surface of the solid electrolyte layer, and an end surface of the positive electrode layer may be collectively inclined obliquely relative to the direction normal to the main surface.

In this way, the end surfaces in each of the unit cells are collectively processed, and thus it is possible to reduce the time required for the step.

For example, the method for manufacturing a battery according to the aspect of the present disclosure may further include: flattening exposed parts of the one or more conductive members and the insulating member before the arranging of the one or more extraction electrodes is performed after the arranging of the insulating member has been performed.

In this way, in the arranging of the one or more extraction electrodes, the extraction electrodes can be arranged on the flat surface, and thus it is possible to realize a decrease in connection resistance between the conductive member and the extraction electrode and the enhancement of reliability.

Embodiments will be specifically described below with reference to drawings.

Each of the embodiments described below shows a comprehensive or specific example. Numerical values, shapes, materials, constituent elements, the arrangement and connection of the constituent elements, steps, the order of the steps, and the like shown in the following embodiments are examples, and are not intended to limit the present disclosure. Among the constituent elements in the following embodiments, constituent elements which are not recited in the independent claims are described as optional constituent elements.

The drawings are schematic views and are not exactly shown. Hence, for example, scales and the like are not necessarily the same in the drawings. In the drawings, substantially the same configurations are identified with the same reference signs, and repeated descriptions are omitted or simplified.

In the present specification, terms such as parallel and orthogonal which indicate relationships between elements, terms such as rectangular and circular which indicate the shapes of elements, and numerical ranges are expressions which not only indicate exact meanings but also indicate substantially equivalent ranges such as a range including a several percent difference.

In the present specification and the drawings, an x-axis, a y-axis, and a z-axis indicate three axes of a three-dimensional orthogonal coordinate system. When the shape of the power generation element of a battery in plan view is a rectangle, the x-axis and the y-axis respectively extend in a direction parallel to a first side of the rectangle and in a direction parallel to a second side orthogonal to the first side. The z-axis extends in the stacking direction of a plurality of unit cells included in the power generation element. In the present specification, the “stacking direction” coincides with a direction normal to the main surfaces of a current collector and an active material layer. In the present specification, the “plan view” is a view when viewed in a direction perpendicular to the main surface unless otherwise specified.

In the present specification, terms of “upward” and “downward” do not indicate an upward direction (vertically upward) and a downward direction (vertically downward) in absolute spatial recognition but are used as terms for defining a relative positional relationship based on a stacking order in a stacking configuration. The terms of “upward” and “downward” are applied not only to a case where two constituent elements are spaced with another constituent element present between the two constituent elements but also to a case where two constituent elements are arranged in close contact with each other to be in contact with each other. In the following description, the negative side of the z-axis is assumed to be “downward” or a “downward side”, and the positive side of the z-axis is assumed to be “upward” or an “upward side”.

In the present specification, unless otherwise specified, the term “protrude” means protruding externally relative to the center of the unit cell in a cross-sectional view orthogonal to the main surface of the unit cell. The sentence “element A protrudes more than element B” means that in the direction of protrusion, the tip end of element A protrudes more than the tip end of element B, that is, the tip end of element A is located more distantly from the center of the unit cell than the tip end of element B. The “direction of protrusion” is regarded as being a direction parallel to the main surface of the unit cell. The “protrusion portion of element A” means a part of element A which protrudes more than the tip end of element B in the direction of protrusion. Examples of the element include an electrode layer, an active material layer, a solid electrolyte layer, a current collector, and the like.

In the present specification, unless otherwise specified, ordinal numbers such as “first” and “second” do not mean the number or order of constituent elements but are used to avoid confusion of similar constituent elements and to distinguish between them.

### Embodiment 1

### [1. Outline]

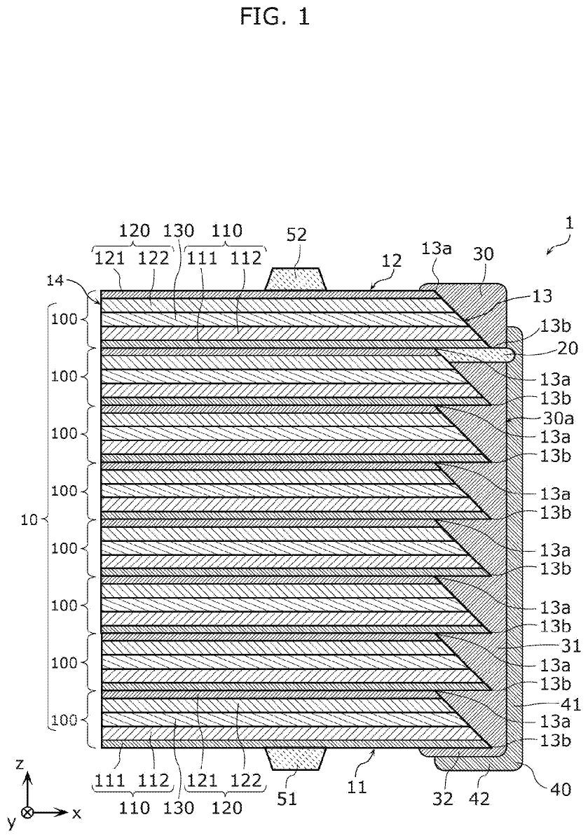

An outline of a battery according to Embodiment 1 will first be described with reference to FIGS. 1 to 3.

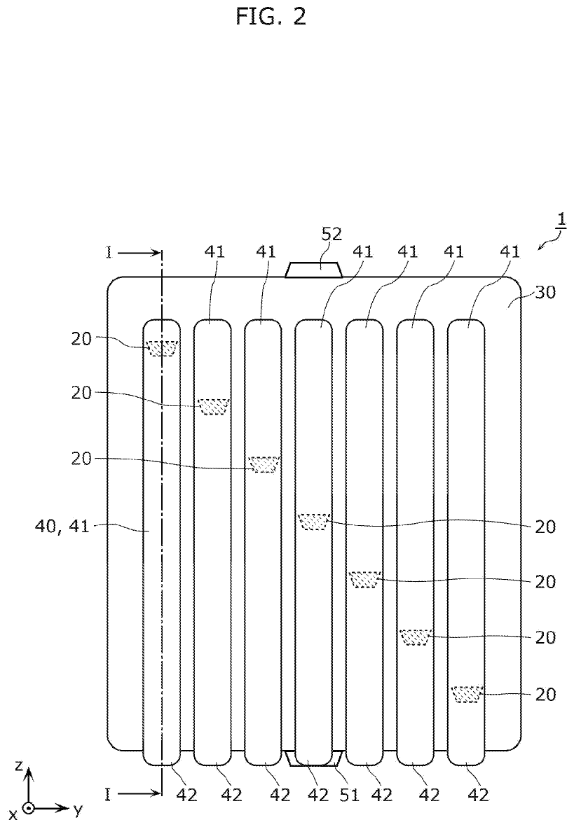

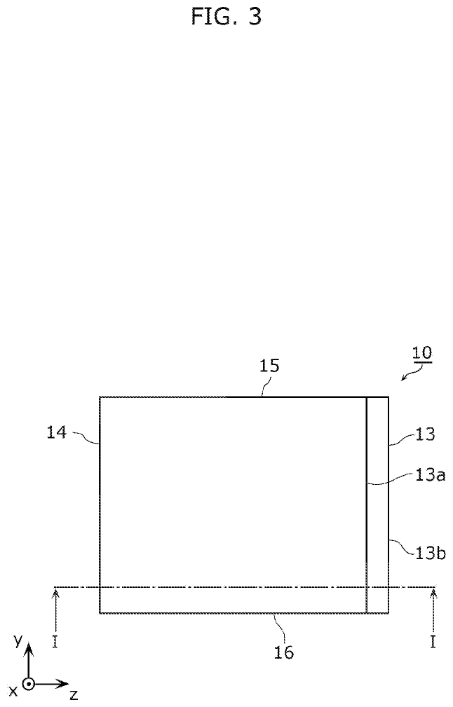

FIG. 1 is a cross-sectional view showing a cross-sectional configuration of battery 1 according to the present embodiment. FIG. 2 is a side view of battery 1 according to the present embodiment. FIG. 3 is a plan view of power generation element 10 of battery 1 according to the present embodiment. Specifically, FIG. 1 shows a cross section taken along line I-I shown in FIGS. 2 and 3.

As shown in FIG. 1, battery 1 according to the present embodiment includes power generation element 10 which includes a plurality of plate-shaped unit cells 100. Unit cells 100 are electrically connected in series and are stacked in a direction normal to a main surface. Battery 1 is, for example, an all solid-state battery. As shown in FIGS. 1 and 2, battery 1 further includes a plurality of conductive members 20, insulating member 30, a plurality of extraction electrodes 40, and electrode terminals 51 and 52.

In an example shown in FIG. 1, power generation element 10 includes eight unit cells 100. The number of unit cells 100 included in power generation element 10 may be two or more, and may two. When the number of unit cells 100 included in power generation element 10 is two, for example, the number of conductive members included in battery 1 is one, and the number of extraction electrodes 40 included in battery 1 is one. Although conductive members 20 are in one-to-one correspondence with extraction electrodes 40, the present embodiment is not limited to this configuration.

Although the shape of power generation element 10 in plan view is rectangular as shown in FIG. 3, the shape is not limited to this shape. The shape of power generation element 10 in plan view may be polygonal such as square, hexagonal, or octagonal, or may be circular, oval, or the like.

As shown in FIG. 1, power generation element 10 includes main surfaces 11 and 12. Main surfaces 11 and 12 face away from each other and are parallel to each other. A direction orthogonal to main surface 11 or main surface 12 is the direction normal to the main surface, and is the direction of the z-axis in the figure. In a cross-sectional view such as FIG. 1, the thickness of each layer is exaggerated to make it easier to understand the layer structure of power generation element 10.

As shown in FIG. 3, power generation element 10 includes side surfaces 13 and 14 which face away from each other and side surfaces 15 and 16 which face away from each other.

In side surface 13, as shown in FIG. 1, depressions 13a and projections 13b which are alternately arranged in the direction normal to the main surface are provided. In side surface 13, negative electrode layer 110 protrudes more than positive electrode layer 120 in each of unit cells 100. Specifically, an end surface of positive electrode layer 120 is an inclination surface which is inclined relative to the direction normal to the main surface, and thus negative electrode layer 110 protrudes more than positive electrode layer 120. Depression 13a includes the inclination surface which is the end surface of positive electrode layer 120. Projection 13b includes an end surface of negative electrode layer 110. Conductive member 20 is provided for each of projections 13b. Conductive member 20 is in contact with corresponding projection 13b.

In the present embodiment, side surface 14 is a flat surface. In side surface 14, as in side surface 13, projections and depressions may be provided, and conductive members, an insulating member, and extraction electrodes may be arranged. When the extraction electrodes are provided in each of side surfaces 13 and 14, it is possible to increase the size of the individual extraction electrode and the interval between the extraction electrodes. Hence, the occurrence of a short circuit via the conductive members or the extraction electrodes can be suppressed.

Side surfaces 15 and 16 are flat surfaces which are parallel to each other. Each of side surfaces 15 and 16 includes the long side of a rectangle when power generation element 10 is viewed in plan view. In this way, since the distance between side surfaces 13 and 14 is increased, when the extraction electrodes are provided in each of side surfaces 13 and 14, the extraction electrodes can be significantly separated from each other, with the result that the occurrence of a short circuit can be suppressed.

Each of side surfaces 13 and 14 may include the long side of the rectangle when power generation element 10 is viewed in plan view. In this way, the size of side surface 13 can be increased, and thus it is possible to increase the size of individual extraction electrode 40 and the interval between extraction electrodes 40. Hence, the occurrence of a short circuit via conductive members 20 or extraction electrodes 40 can be suppressed.

In the configuration described above, the voltage of negative electrode layers 110 of unit cells 100 can be drawn from side surface 13, and thus voltage in the unit cell can be monitored, with the result that it is possible to suppress overcharging or overdischarging.

### [2. Configuration of Unit Cell]

The configuration of unit cell 100 will then be described with reference to FIG. 1.

As shown in FIG. 1, each of unit cells 100 includes negative electrode layer 110, positive electrode layer 120, and solid electrolyte layer 130 located between negative electrode layer 110 and positive electrode layer 120. Negative electrode layer 110 is an example of an electrode layer, and includes negative electrode current collector 111 and negative electrode active material layer 112. Positive electrode layer 120 is an example of the electrode layer, and includes positive electrode current collector 121 and positive electrode active material layer 122. In each of unit cells 100, negative electrode current collector 111, negative electrode active material layer 112, solid electrolyte layer 130, positive electrode active material layer 122, and positive electrode current collector 121 are stacked in this order in the direction normal to the main surface.

The configurations of unit cells 100 are the same as each other. In two adjacent unit cells 100, the order of arrangement of the individual layers is the same.

Each of negative electrode current collector 111 and positive electrode current collector 121 is a conductive member which is foil-shaped, plate-shaped, or mesh-shaped. Each of negative electrode current collector 111 and positive electrode current collector 121 may be, for example, a conductive thin film. Examples of the material of negative electrode current collector 111 and positive electrode current collector 121 which can be used include metals such as stainless steel (SUS), aluminum (Al), copper (Cu), and nickel (Ni). Negative electrode current collector 111 and positive electrode current collector 121 may be formed using different materials.

Although the thickness of each of negative electrode current collector 111 and positive electrode current collector 121 is, for example, greater than or equal to 5 μm and less than or equal to 100 μm, the thickness is not limited to this range. Negative electrode active material layer 112 is in contact with the main surface of negative electrode current collector 111. Negative electrode current collector 111 may include a current collector layer which is provided in a part where negative electrode current collector 111 is in contact with negative electrode active material layer 112 and which includes a conductive material. Positive electrode active material layer 122 is in contact with the main surface of positive electrode current collector 121. Positive electrode current collector 121 may include a current collector layer which is provided in a part where positive electrode current collector 121 is in contact with positive electrode active material layer 122 and which includes a conductive material.

Negative electrode active material layer 112 is arranged on the main surface of negative electrode current collector 111 on the side of positive electrode layer 120. Negative electrode active material layer 112 includes, for example, a negative electrode active material as an electrode material. Negative electrode active material layer 112 is arranged opposite positive electrode active material layer 122.

As the negative electrode active material contained in negative electrode active material layer 112, for example, a negative electrode active material such as graphite or metallic lithium can be used. As the material of the negative electrode active material, various types of materials which can withdraw and insert ions of lithium (Li), magnesium (Mg), or the like can be used.

As a material contained in negative electrode active material layer 112, for example, a solid electrolyte such as an inorganic solid electrolyte may be used. Examples of the inorganic solid electrolyte which can be used include a sulfide solid electrolyte, an oxide solid electrolyte, and the like. As the sulfide solid electrolyte, for example, a mixture of lithium sulfide (Li₂S) and phosphorus pentasulfide (P₂S₅) can be used. As the material contained in negative electrode active material layer 112, for example, a conductive material such as acetylene black, a binder for binding such as polyvinylidene fluoride, or the like may be used.

A paste-like paint in which the material contained in negative electrode active material layer 112 is kneaded together with a solvent is applied on the main surface of negative electrode current collector 111 and is dried, and thus negative electrode active material layer 112 is produced. After the drying, negative electrode layer 110 (which is also referred to as the negative electrode plate) including negative electrode active material layer 112 and negative electrode current collector 111 may be pressed so that the density of negative electrode active material layer 112 is increased. Although the thickness of negative electrode active material layer 112 is, for example, greater than or equal to 5 μm and less than or equal to 300 μm, the thickness is not limited to this range.

Positive electrode active material layer 122 is arranged on the main surface of positive electrode current collector 121 on the side of negative electrode layer 110. Positive electrode active material layer 122 is, for example, a layer which includes a positive electrode material such as an active material. The positive electrode material is a material which forms the counter electrode of the negative electrode material. Positive electrode active material layer 122 includes, for example, a positive electrode active material.

Examples of the positive electrode active material contained in positive electrode active material layer 122 which can be used include lithium cobaltate composite oxide (LCO), lithium nickelate composite oxide (LNO), lithium manganate composite oxide (LMO), lithium-manganese-nickel composite oxide (LMNO), lithium-manganese-cobalt composite oxide (LMCO), lithium-nickel-cobalt composite oxide (LNCO), lithium-nickel-manganese-cobalt composite oxide (LNMCO), and the like. As the material of the positive electrode active material, various types of materials which can withdraw and insert ions of Li, Mg, or the like can be used.

As the material contained in positive electrode active material layer 122, for example, a solid electrolyte such as an inorganic solid electrolyte may be used. Examples of the inorganic solid electrolyte which can be used include a sulfide solid electrolyte, an oxide solid electrolyte, and the like. As the sulfide solid electrolyte, for example, a mixture of Li₂S and P₂S₅ can be used. The surface of the positive electrode active material may be coated with a solid electrolyte. As the material contained in positive electrode active material layer 122, for example, a conductive material such as acetylene black, a binder for binding such as polyvinylidene fluoride, or the like may be used.

A paste-like paint in which the material contained in positive electrode active material layer 122 is kneaded together with a solvent is applied on the main surface of positive electrode current collector 121 and is dried, and thus positive electrode active material layer 122 is produced. After the drying, positive electrode layer 120 (which is also referred to as the positive electrode plate) including positive electrode active material layer 122 and positive electrode current collector 121 may be pressed so that the density of positive electrode active material layer 122 is increased. Although the thickness of positive electrode active material layer 122 is, for example, greater than or equal to 5 μm and less than or equal to 300 μm, the thickness is not limited to this range.

Solid electrolyte layer 130 is arranged between negative electrode active material layer 112 and positive electrode active material layer 122. Solid electrolyte layer 130 is in contact with negative electrode active material layer 112 and positive electrode active material layer 122. Solid electrolyte layer 130 is a layer which includes an electrolyte material. As the electrolyte material, a known battery electrolyte can be generally used. The thickness of solid electrolyte layer 130 may be greater than or equal to 5 μm and less than or equal to 300 μm or may be greater than or equal to 5 μm and less than or equal to 100 μm.

Solid electrolyte layer 130 includes a solid electrolyte. As the solid electrolyte, for example, a solid electrolyte such as an inorganic solid electrolyte can be used. Examples of the inorganic solid electrolyte which can be used include a sulfide solid electrolyte, an oxide solid electrolyte, and the like. As the sulfide solid electrolyte, for example, a mixture of Li₂S and P₂S₅ can be used. Solid electrolyte layer 130 may contain, in addition to the electrolyte material, for example, a binder for binding such as polyvinylidene fluoride or the like.

In the present embodiment, negative electrode active material layer 112, positive electrode active material layer 122, and solid electrolyte layer 130 are maintained in a parallel flat plate shape. In this way, it is possible to suppress the occurrence of a crack or a collapse caused by bending. Negative electrode active material layer 112, positive electrode active material layer 122, and solid electrolyte layer 130 may be combined and smoothly curved.

Negative electrode active material layer 112 may be smaller than negative electrode current collector 111 in plan view. In other words, in the main surface of negative electrode current collector 111 on the side of positive electrode layer 120, a part where negative electrode active material layer 112 is not provided may be present. Likewise, positive electrode active material layer 122 may be smaller than positive electrode current collector 121 in plan view. In other words, in the main surface of positive electrode current collector 121 on the side of negative electrode layer 110, a part where positive electrode active material layer 122 is not provided may be present. In the part of the main surface of each current collector where the active material layer is not provided, solid electrolyte layer 130 may be provided.

### [3. Structure of End Surface of Unit Cell]

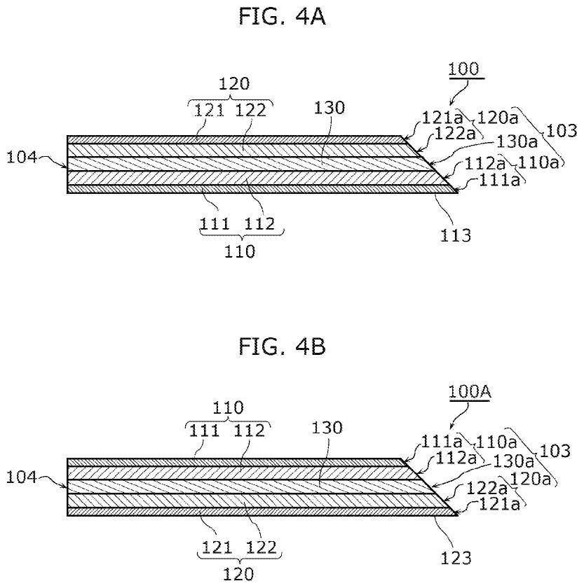

The structure of the end surface of unit cell 100 will then be described with reference to FIG. 4A. FIG. 4A is a cross-sectional view showing a cross-sectional structure of unit cell 100 included in power generation element 10 in the present embodiment.

Unit cell 100 shown in FIG. 4A is one of unit cells 100 shown in FIG. 1. Unit cell 100 includes protrusion portion 113 in which negative electrode layer 110 protrudes more than positive electrode layer 120.

Protrusion portion 113 is formed by obliquely cutting the end surface of plate-shaped unit cell 100 relative to the direction normal to the main surface. In the present embodiment, the end surface of unit cell 100 is collectively cut, and thus the end surface is formed into an inclination surface serving as a flat surface which is inclined relative to the direction normal to the main surface.

Specifically, end surface 103 of unit cell 100 includes end surface 110a of negative electrode layer 110, end surface 120a of positive electrode layer 120, and end surface 130a of solid electrolyte layer 130. End surfaces 110a, 120a, and 130a described above are flush with each other. End surface 103 may be a curved surface which is convex or concave. End surface 103 may include a plurality of inclination surfaces whose inclination angles are different.

End surface 110a of negative electrode layer 110 is an example of a second inclination surface which is inclined relative to the direction normal to the main surface. End surface 110a includes end surface 111a of negative electrode current collector 111 and end surface 112a of negative electrode active material layer 112. End surfaces 111a and 112a are flush with each other.

End surface 120a of positive electrode layer 120 is an example of a first inclination surface which is inclined relative to the direction normal to the main surface. End surface 120a includes end surface 121a of positive electrode current collector 121 and end surface 122a of positive electrode active material layer 122. End surfaces 121a and 122a are flush with each other.

End surface 110a of negative electrode layer 110 does not need to be an inclination surface, and may be a surface which is orthogonal to the main surface. At least a part of end surface 130a of solid electrolyte layer 130 may be a surface which is orthogonal to the main surface. In other words, only end surface 120a of positive electrode layer 120 or only end surface 120a and a part of end surface 130a of solid electrolyte layer 130 may be an inclination surface.

In the present embodiment, end surface 104 of unit cell 100 is a surface which is orthogonal to the main surface. In end surface 104, as in end surface 103, a protrusion portion may be provided. The protrusion portion may be a part in which negative electrode layer 110 protrudes more than positive electrode layer 120. In this case, the cross-sectional shape of unit cell 100 is, for example, a trapezoid having a longer side on negative electrode layer 110, such as an isosceles trapezoid. The protrusion portion may also be a part in which positive electrode layer 120 protrudes more than negative electrode layer 110. In this case, the cross-sectional shape of unit cell 100 is, for example, a parallelogram or the like.

In end surface 103, instead of negative electrode layer 110, positive electrode layer 120 may protrude. FIG. 4B is a cross-sectional view showing a cross-sectional structure of another example of the unit cell included in the power generation element in the present embodiment. In end surface 103 of unit cell 100A shown in FIG. 4B, protrusion portion 123 is provided in which positive electrode layer 120 protrudes more than negative electrode layer 110. In this case, end surface 110a of negative electrode layer 110 is an example of the first inclination surface, and end surface 120a of positive electrode layer 120 is an example of the second inclination surface. In unit cell 100A, a protrusion portion may also be provided in end surface 104.

### [4. Structure of Side Surface of Power Generation Element]

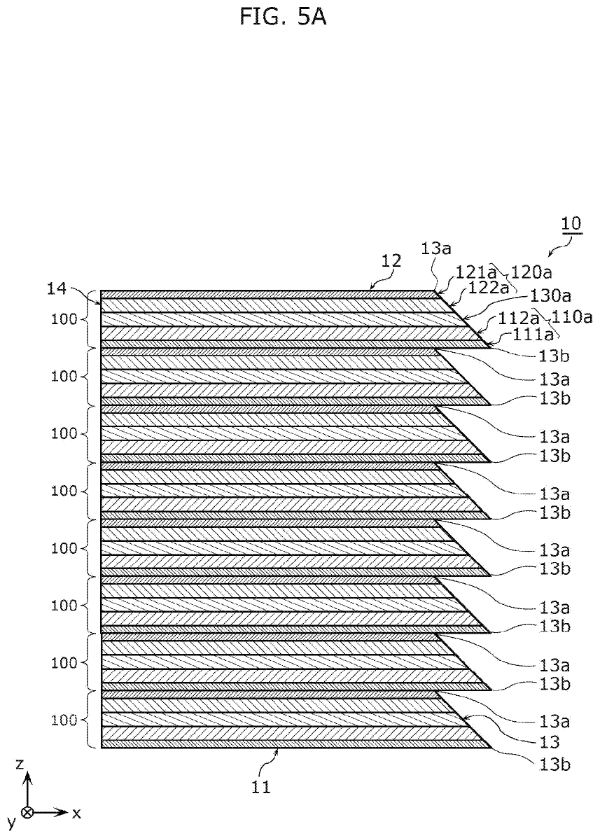

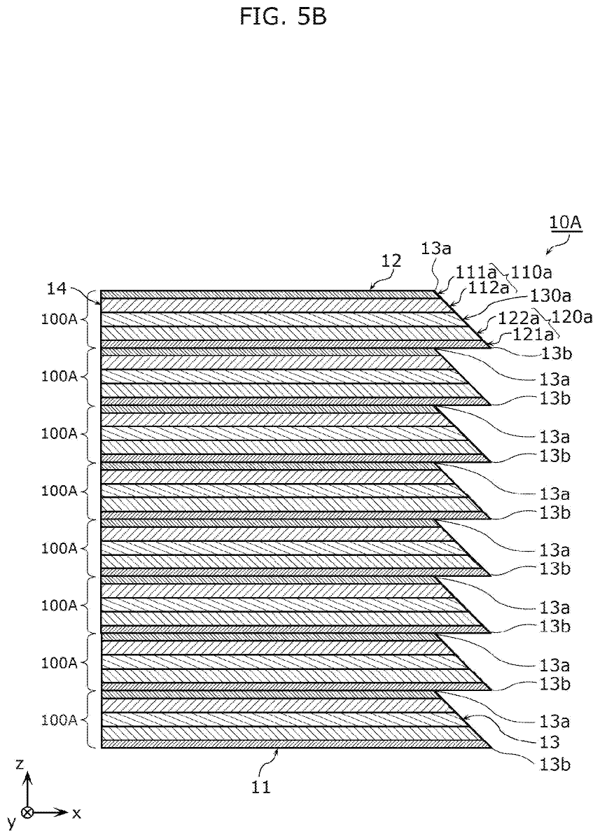

The structure of the side surface of power generation element will then be described with reference to FIG. 1 as necessary by use of FIGS. 4A, 4B, 5A, and 5B.

A plurality of unit cells 100 shown in FIG. 4A are stacked such that the direction of arrangement of the individual layers is the same and protrusion portions 113 of unit cells 100 are aligned, and thus it is possible to form power generation element 10 shown in FIG. 5A. Here, FIG. 5A is a cross-sectional view showing a cross-sectional configuration of power generation element 10 shown in FIG. 1.

As shown in FIG. 5A, between two adjacent unit cells 100, two current collectors of the same polarity are arranged to overlap each other. Here, an adhesive layer may be provided between the current collectors. Although the adhesive layer is, for example, conductive, the adhesive layer does not need to be conductive.

In side surface 13 of power generation element 10, protrusion portions 113 of negative electrode layers 110 are aligned to form projections 13b. Here, the “aligned” means that in plan view, that is, when viewed in the direction of the z-axis, a plurality of protrusion portions 113 overlap each other. In the present embodiment, in side surface 13, negative electrode layer 110 protrudes to provide projection 13b, and positive electrode layer 120 is depressed to provide depression 13a. In power generation element 10, the same number of projections 13b and the same number of depressions 13a as the number of unit cells 100 stacked are provided. In the example shown in FIGS. 1 and 5A, eight projections 13b and eight depressions 13a are arranged alternately and repeatedly in the direction normal to the main surface.

Depression 13a includes end surface 120a of positive electrode layer 120. End surface 120a is an inclination surface, and thus depression 13a is formed. The inclination angle of end surface 120a is defined as an angle formed by main surface 11 and end surface 120a, and is, for example, greater than or equal to 30° and less than or equal to 60°. Although the inclination angle is 45° as an example, the inclination angle is not limited to this angle. As the inclination angle is decreased, deeper depression 13a can be formed, and thus it is possible to suppress the occurrence of a short circuit. As the inclination angle is increased, a larger effective area of unit cell 100 can be secured, and thus it is possible to achieve a high capacity density.

Projection 13b includes end surface 110a of negative electrode layer 110. End surface 110a is an inclination surface, and thus the distance between the tip end of projection 13b and depression 13a can be increased.

A plurality of unit cells 100A shown in FIG. 4B may be stacked such that the direction of arrangement of the individual layers is the same and protrusion portions 123 of unit cells 100A are aligned. In this way, it is possible to form power generation element 10A shown in FIG. 5B. FIG. 5B is a cross-sectional view showing a cross-sectional configuration of a variation of the power generation element in the present embodiment.

### [5. Conductive Member]

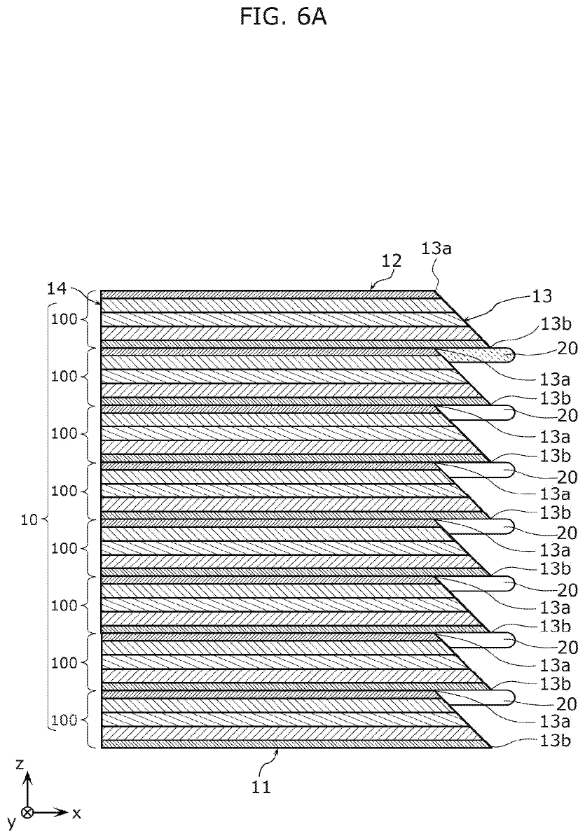

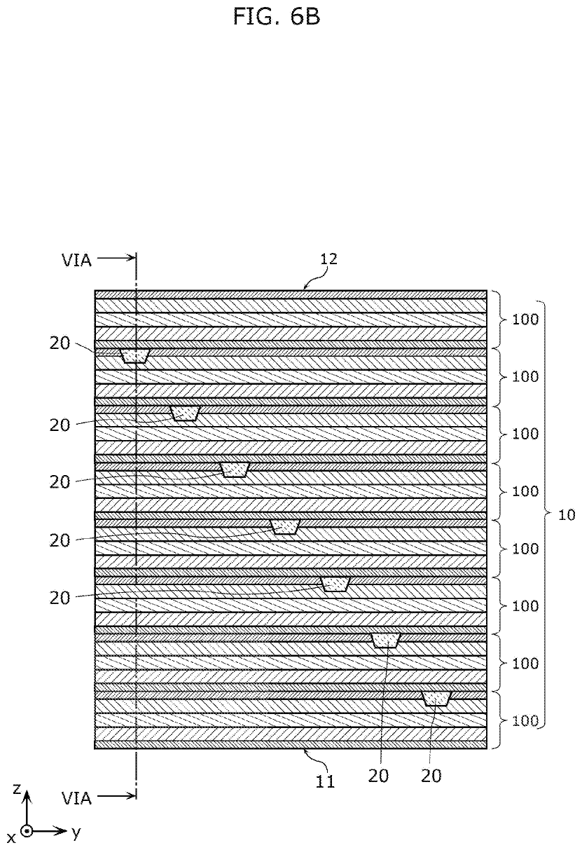

Conductive members 20 will then be described with reference to FIG. 1 as necessary by use of FIGS. 6A and 6B.

FIG. 6A is a cross-sectional view showing a cross-sectional configuration of battery 1 after a step of arranging conductive members 20 in a method for manufacturing battery 1 according to the present embodiment. FIG. 6B is a side view of battery 1 shown in FIG. 6A. FIG. 6A shows a cross section taken along line VIA-VIA in FIG. 6B. In FIG. 6B, the same hatching as in the layers in FIG. 6A is used so that correspondence with FIG. 6A can easily be understood.

As shown in FIGS. 6A and 6B, conductive member 20 is provided for each of projections 13b, and is in contact with corresponding projection 13b. Conductive member 20 is not provided for projection 13b in the lowermost layer.

In corresponding projection 13b, conductive member 20 is in contact with a main surface of negative electrode layer 110. Specifically, conductive member 20 is in contact with the main surface of negative electrode current collector 111 on a side opposite to the surface on which negative electrode active material layer 112 is provided. Depression 13a is provided, that is, the end surface of adjacent unit cell 100 is an inclination surface, and thus an end of the main surface of negative electrode current collector 111 is exposed, with the result that conductive member 20 can be brought into contact with the end of the main surface. Conductive member 20 and the main surface of negative electrode current collector 111 are connected, and thus the connection area is increased, with the result that strong physical bonding and a stable electrical connection are realized.

As shown in FIG. 6A, conductive member 20 is provided from the bottom of depression 13a to the tip end of projection 13b, and a part of conductive member 20 protrudes more than projection 13b. In other words, conductive member 20 is also in contact with positive electrode current collector 121 of adjacent unit cell 100, that is, end surface 121a (see FIG. 5A) of positive electrode current collector 121 which is exposed to depression 13a. In this way, it is possible to increase mechanical connection strength between positive electrode current collector 121 and negative electrode current collector 111 and to reduce the resistance of battery 1 in the series connection.

In depression 13a, conductive member 20 may be in contact with end surface 122a (see FIG. 5A) of positive electrode active material layer 122. Conductive member 20 may also be in contact with end surface 130a (see FIG. 5A) of solid electrolyte layer 130. However, conductive member 20 is not in contact with projection 13b of adjacent unit cell 100, and is specifically not in contact with negative electrode layer 110 of adjacent unit cell 100. As described above, conductive member 20 is provided to connect to the end surface of the layer including the active material, and thus it is possible to suppress the collapse of the active material layer. Hence, the mechanical strength of battery 1 can be enhanced, and the reliability of the battery can be enhanced.

In the present embodiment, as shown in FIG. 6B, conductive members 20 provided for projections 13b are provided so as not to make contact with each other. Specifically, a plurality of conductive members 20 do not overlap each other when viewed in the direction of the z-axis. For example, although conductive members 20 are provided obliquely in a row, the present embodiment is not limited to this configuration. The arrangement of conductive members 20 may be random. The positions of conductive members 20 are displaced, and thus it is possible to easily arrange extraction electrodes 40.

Conductive members 20 are formed using a resin material or the like which is conductive. Conductive members 20 may also be formed using a metal material such as solder. Although conductive members 20 are formed using the same material, they may be formed using different materials.

### [6. Insulating Member]

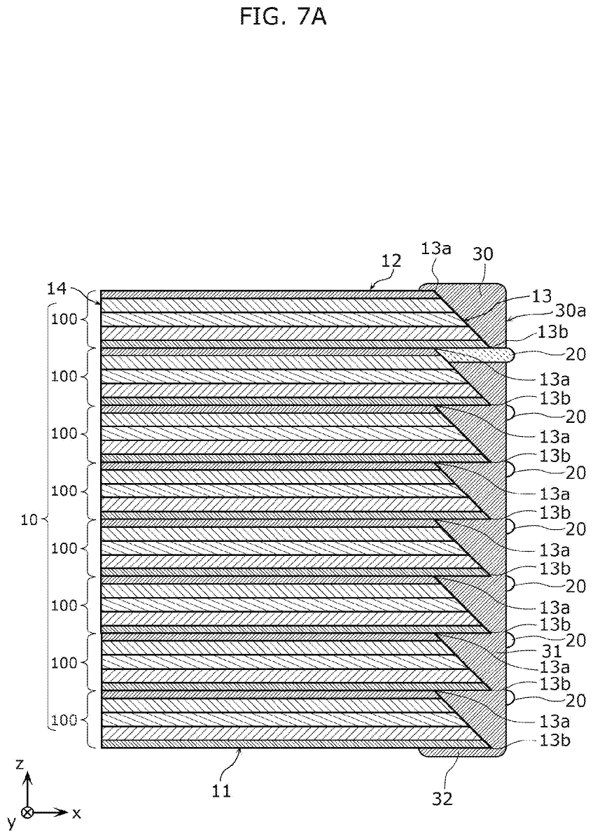

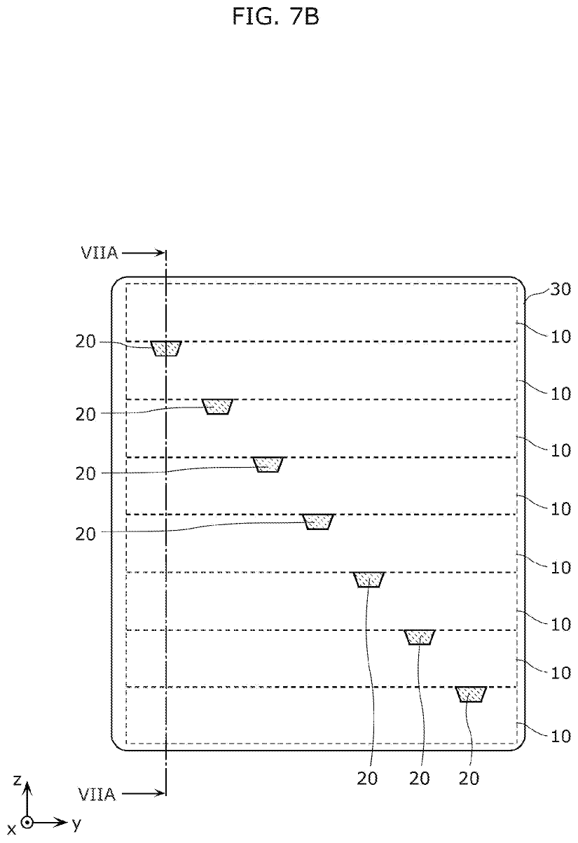

Insulating member 30 will then be described with reference to FIG. 1 as necessary by use of FIGS. 7A and 7B.

FIG. 7A is a cross-sectional view showing a cross-sectional configuration of battery 1 after a step of arranging insulating member in the method for manufacturing battery 1 according to the present embodiment. FIG. 7B is a side view of battery 1 shown in FIG. 7A. FIG. 7A shows a cross section taken along line VIIA-VIIA in FIG. 7B.

As shown in FIGS. 7A and 7B, insulating member 30 covers side surface 13 of power generation element 10 to expose at least a part of each of conductive members 20. Each of conductive members 20 protrudes from outer surface 30a of insulating member 30.

In the present embodiment, insulating member 30 continuously covers from side surface 13 to ends of main surfaces 11 and 12 of power generation element 10. In other words, a part of insulating member 30 is provided to be in contact with main surface 11, and another part is provided to be in contact with main surface 12. As shown in FIG. 7A, insulating member 30 is provided to wrap around projection 13b in the lowermost layer.

Specifically, insulating member 30 includes side surface cover portion 31 and end cover portion 32. Side surface cover portion 31 is a part which covers side surface 13 of power generation element Side surface cover portion 31 is provided to fill depressions 13a and to cover projections 13b. End cover portion 32 is a part which is continuous from side surface cover portion 31 and overlaps main surface 11 of power generation element 10 when main surface 11 is viewed in plan view. End cover portion 32 is in contact with and covers the end of main surface 11.

As shown in FIG. 7B, insulating member 30 covers entire side surface 13 except parts in which conductive members 20 are provided. Insulating member 30 may further cover at least a part of side surface or side surface 16. Insulating member 30 may also further cover side surface 14. Insulating member 30 may be provided for each of conductive members 20. Specifically, insulating member 30 may be provided for each of conductive members 20 or for each of extraction electrodes 40 in the shape of an island when viewed from the positive side of the x-axis.

Insulating member 30 is formed using an insulating material which is electrically insulating. Although as the insulating material, for example, an epoxy resin material can be used, an inorganic material may be used. The insulating material which can be used is selected based on various properties such as flexibility, a gas barrier property, impact resistance, and heat resistance. Insulating member may have a multilayer structure in which layers have different properties.

### [7. Extraction Electrode and Electrode Terminal]

Extraction electrodes 40 and electrode terminals 51 and 52 will then be described with reference to FIGS. 1 and 2.

Extraction electrodes 40 correspond to respective conductive members 20, and are in contact with conductive members 20 exposed from outer surface 30a of insulating member 30 and outer surface of insulating member 30. Extraction electrode 40 is an intermediate electrode for monitoring in order to monitor an intermediate voltage that is the voltage of unit cell 100 to which corresponding conductive member 20 is connected. As shown in FIG. 1, extraction electrode 40 includes side surface cover portion 41 and end cover portion 42.

Side surface cover portion 41 is a part which extends along the direction normal to the main surface and is in an elongated shape. As shown in FIG. 1, side surface cover portion 41 is in contact with and covers exposed parts of conductive members 20. As shown in FIG. 2, side surface cover portion 41 of each of extraction electrodes is provided in a stripe shape.

Although FIG. 2 shows an example where a plurality of side surface cover portions 41 have the same shape and size, the present embodiment is not limited to this configuration. The shapes and sizes of side surface cover portions 41 may be different from each other. For example, the length of side surface cover portion 41 in the direction of the z-axis may be set based on the position of conductive member 20 to which side surface cover portion 41 is connected. In an example shown in FIG. 2, the length of side surface cover portion 41 in the direction of the z-axis may be shortened toward the positive side of the y-axis. In this way, it is possible to easily determine extraction electrode 40, that is, to easily determine to which one of unit cells 100 the extraction electrode is connected.

End cover portion 42 is a part which is continuous from side surface cover portion 41 and overlaps insulating member 30 when main surface 11 is viewed in plan view. In other words, end cover portion 42 covers end cover portion 32 which is a part of insulating member 30 and which covers main surface 11. End cover portion 42 functions as an electrical connection terminal for a substrate on which battery 1 is mounted.

Electrode terminal 51 is provided on main surface 11. Since in the present embodiment, main surface 11 is a main surface of negative electrode current collector 111, electrode terminal 51 is an extraction electrode for the negative electrode of power generation element 10.

Electrode terminal 52 is provided on main surface 12. Since in the present embodiment, main surface 12 is a main surface of positive electrode current collector 121, electrode terminal 52 is an extraction electrode for the positive electrode of power generation element 10.

As shown in FIG. 2, a plurality of end cover portions 42 and electrode terminal 51 have the same height when main surface 11 is a reference surface. The height here is the length in the direction of the z-axis. Hence, battery 1 is easily mounted on a flat substrate. Air gaps are formed between battery 1 and a mounting substrate, and thus heat dissipation performance is enhanced.

End cover portions 42 may be provided on main surface 12. A part of end cover portions 42 may be provided on main surface 11, and the other part may be provided on main surface 12.

Extraction electrodes 40 and electrode terminals 51 and 52 each are formed using a resin material or the like which is conductive. Extraction electrodes 40 and electrode terminals 51 and 52 may also be formed using a metal material such as solder. The conductive material which can be used is selected based on various properties such as flexibility, a gas barrier property, impact resistance, heat resistance, and solder wettability. Although extraction electrodes 40 and electrode terminals 51 and 52 are formed using the same material, they may be formed using different materials.

### [8. Manufacturing Method]

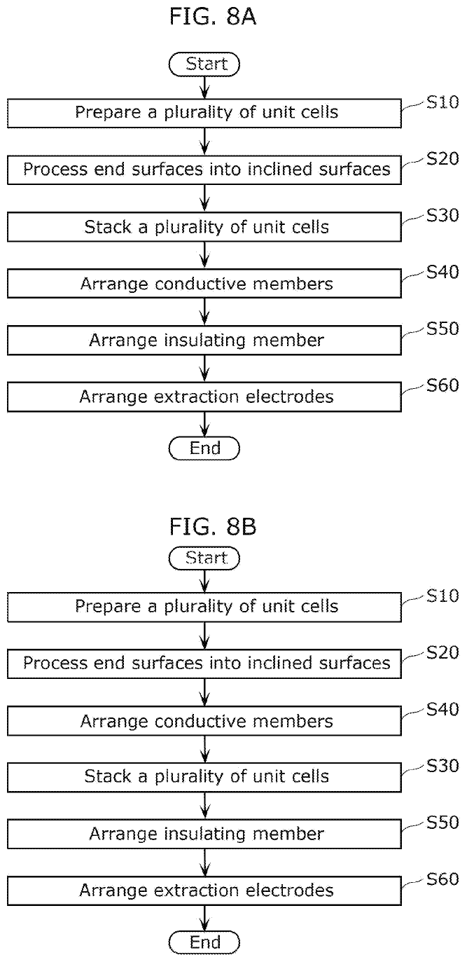

A method for manufacturing battery 1 will then be described with reference to FIG. 8A.

FIG. 8A is a flowchart showing a method for manufacturing battery 1 according to the present embodiment.

As shown in FIG. 8A, a plurality of plate-shaped unit cells are first prepared (S10). The prepared unit cells are, for example, unit cells in which the end surfaces of unit cells 100 shown in FIG. 4A have not been processed. Although the end surfaces which have not been processed are, for example, flat surfaces orthogonal to the main surface, they may be inclination surfaces.

Then, the end surfaces of prepared unit cells 100 are processed to be inclined (S20). Specifically, in the end surface of each of unit cells 100, the end surface of positive electrode layer 120 is processed into an inclination surface, and thus negative electrode layer 110 is caused to protrude more than positive electrode layer 120. In the present embodiment, the end surfaces of the unit cells are collectively processed. Hence, the end surfaces of negative electrode layer 110, positive electrode layer 120, and solid electrolyte layer 130 are inclination surfaces. In this way, unit cells 100 whose end surfaces are inclination surfaces are formed. The end surface of negative electrode layer 110 may be processed into an inclination surface, and thus positive electrode layer 120 may be caused to protrude more than negative electrode layer 110. In this way, it is possible to form unit cell 100A shown in FIG. 4B.

The end faces are processed by cutting using a cutting blade or polishing. The cutting blade is obliquely inclined relative to the direction normal to the main surface, and thus the end surfaces of the unit cells are formed into the inclination surfaces.

Examples of a cutting method which can be used include shear cutting, score cutting, razor cutting, ultrasonic cutting, laser cutting, jet cutting, and other various types of cutting. For example, in the shear cutting, various types of cutting blades such as a Goebel slitting blade, a gang slitting blade, a rotary chopper blade, and a shear blade can be used. A Thomson blade can also be used.

As the polishing, physical or chemical polishing can be utilized. The method for forming the inclination surface is not limited to these methods.

Then, a plurality of unit cells 100 are stacked (S30). Specifically, positive electrode layer 120 and negative electrode layer 110 are caused to face each other, protrusion portions 113 of negative electrode layers 110 are aligned, and thus unit cells 100 are stacked. In this way, for example, power generation element 10 shown in FIG. 5A is formed.

Then, for each of protrusion portions 113 of negative electrode layers 110, conductive member 20 which is brought into contact with protrusion portion 113 is arranged (S40). Conductive members 20 are arranged, for example, by applying and curing a viscous conductive resin material or a metal material such as solder. The application is performed by inkjet or screen printing. The curing is performed by drying, heating, application of light, or the like depending on the material used. Conductive members 20 may be formed by performing, on a metal material, printing, plating, vapor deposition, sputtering, welding, soldering, joining, or another method.

Then, insulating member 30 is arranged to expose at least a part of conductive members 20. For example, an insulating resin material is applied and cured to cover entire side surface 13 around conductive members 20, and thus insulating member 30 is arranged. The application is performed by inkjet or screen printing. The curing is performed by drying, heating, application of light, or the like depending on the material used.

Then, extraction electrodes 40 corresponding to conductive members 20 are arranged (S60). Specifically, extraction electrodes are brought into contact with parts of conductive members 20 exposed from outer surface 30a of insulating member 30 and outer surface 30a so as to be arranged. Extraction electrodes 40 can be formed, for example, by performing, on a conductive resin material or a metal material, printing, plating, vapor deposition, sputtering, welding, soldering, joining, or another method.

Battery 1 shown in FIG. 1 can be manufactured through the steps described above.

In steps S10 and S20, one large unit cell is prepared, and the prepared unit cell is obliquely cut into pieces, with the result that a plurality of unit cells whose end surfaces are inclination surfaces may be formed. In other words, steps S10 and S20 may be performed in the same step.

A step of individually pressing the prepared unit cells in the direction normal to the main surface or a step of stacking a plurality of unit cells and thereafter pressing them in the direction normal to the main surface may be performed.

Although an example is shown in FIG. 8A where the arrangement of conductive members 20 (S40) is performed after the stacking of the unit cells (S30), the present embodiment is not limited to this example. As shown in FIG. 8B, the stacking of the unit cells (S30) may be performed after the arrangement of conductive members 20 (S40). FIG. 8B is a flowchart showing another example of the method for manufacturing battery 1 according to the present embodiment.

In an example shown in FIG. 8B, conductive members 20 are arranged to make contact with protrusion portions 113 of unit cells 100 which have not been stacked. In other words, conductive members 20 are individually arranged on the main surfaces of negative electrode current collectors 111 included in protrusion portions 113 of the unit cells, and thereafter the unit cells are stacked. In the example shown in FIG. 8B, before the stacking of unit cells 100 after the arrangement of conductive members 20, the insulating member may be arranged.

In FIGS. 8A and 8B, in step S10, unit cells in which the inclination surfaces are previously formed in the end surfaces may be prepared. In other words, unit cells 100 or unit cells 100A shown in FIG. 4A or FIG. 4B may be prepared. In this case, processing (S20) in which the end surfaces are processed can be omitted.

### Embodiment 2

Embodiment 2 will then be described.

Embodiment 2 differs from Embodiment 1 in that in the method for manufacturing a battery, a step of flattening the conductive members and the insulating member is included. Differences from Embodiment 1 will be mainly described below, and the description of common points will be omitted or simplified.

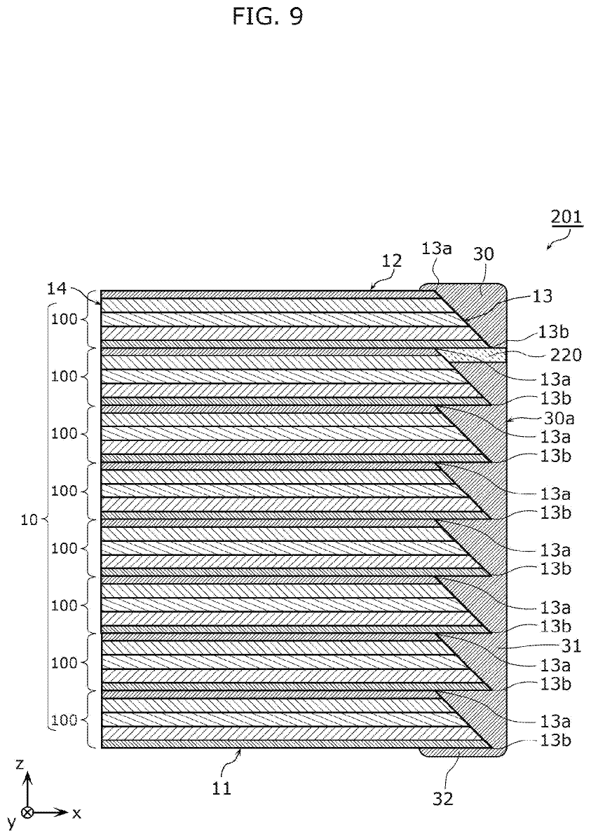

The configuration of a battery according to the present embodiment will first be described with reference to FIG. 9. FIG. 9 is a cross-sectional view showing a cross-sectional configuration of battery 201 according to the present embodiment.

As shown in FIG. 9, battery 201 differs from battery 1 according to Embodiment 1 in that battery 201 includes conductive members 220 instead of conductive members 20. Although battery 201 includes extraction electrodes 40 and electrode terminals 51 and 52 as in Embodiment 1, the illustration thereof is omitted in FIG. 9.

Conductive members 220 differ from conductive members 20 according to Embodiment 1 in that exposed parts of conductive members 220 are flush with outer surface 30a of insulating member 30. For example, parts of conductive members 20 shown in FIG. 7A which protrude from outer surface 30a are removed and flattened, and thus conductive members 220 shown in FIG. 9 can be formed.

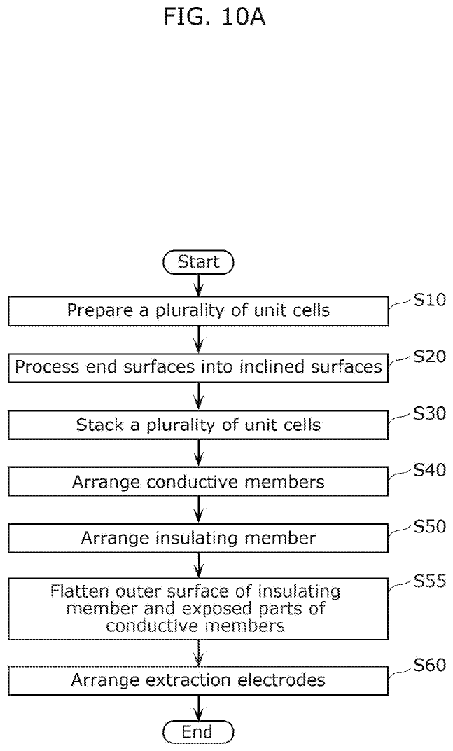

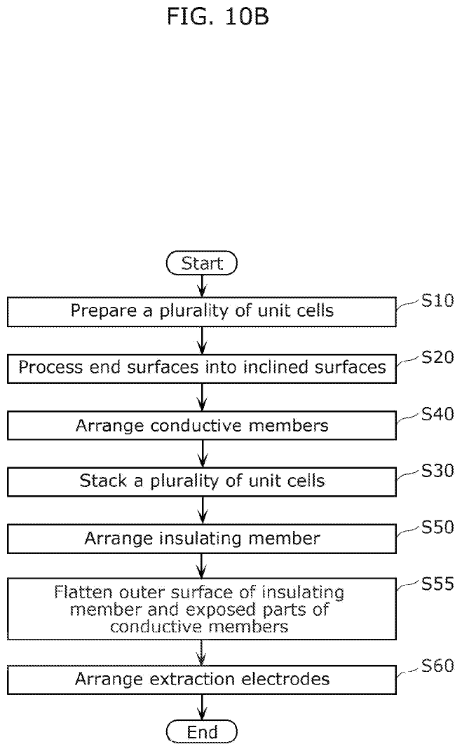

A method for manufacturing battery 201 according to the present embodiment will then be described with reference to FIGS. 10B and 10B.

FIG. 10A is a flowchart showing an example of the method for manufacturing battery 201 according to the present embodiment. As shown in FIG. 10A, steps (from S10 to S50) up to the step of arranging insulating member 30 are the same as those shown in FIG. 8A in Embodiment 1. In step S50, insulating member 30 may be arranged to cover conductive members 220. A shortage of insulating member 30 can be avoided, and thus the occurrence of a short circuit can be avoided.

In the present embodiment, after the arrangement of insulating member 30, outer surface 30a of insulating member 30 and the exposed parts of conductive members 220 are flattened (S55). Specifically, until the exposed parts of conductive members 220 and outer surface 30a are flush with each other, the exposed parts are polished. Instead of the polishing, cutting may be performed. Not only the exposed parts of conductive members 220 but also insulating member 30 may be polished or cut.

After they are flattened, extraction electrodes 40 are arranged to cover the exposed parts of conductive members 220 and outer surface 30a of insulating member 30 (S60). The surfaces on which extraction electrodes 40 are arranged are flat, and thus it is possible to accurately arrange extraction electrodes 40.

Although an example is shown where the arrangement of conductive members 220 (S40) is performed after the stacking of the unit cells (S30) as in Embodiment 1, the present embodiment is not limited to this example. As shown in FIG. 10B, the stacking of the unit cells (S30) may be performed after the arrangement of conductive members 220 (S40).

In FIGS. 10A and 10B, in step S10, unit cells in which the inclination surfaces are previously formed in the end surfaces may be prepared. In other words, unit cells 100 or unit cells 100A shown in FIG. 4A or FIG. 4B may be prepared. In this case, processing (S20) in which the end surfaces are processed can be omitted.

### Embodiment 3

Embodiment 3 will then be described.

Embodiment 3 differs from Embodiment 1 in that a battery includes a sealing member. Differences from Embodiment 1 will be mainly described below, and the description of common points will be omitted or simplified.

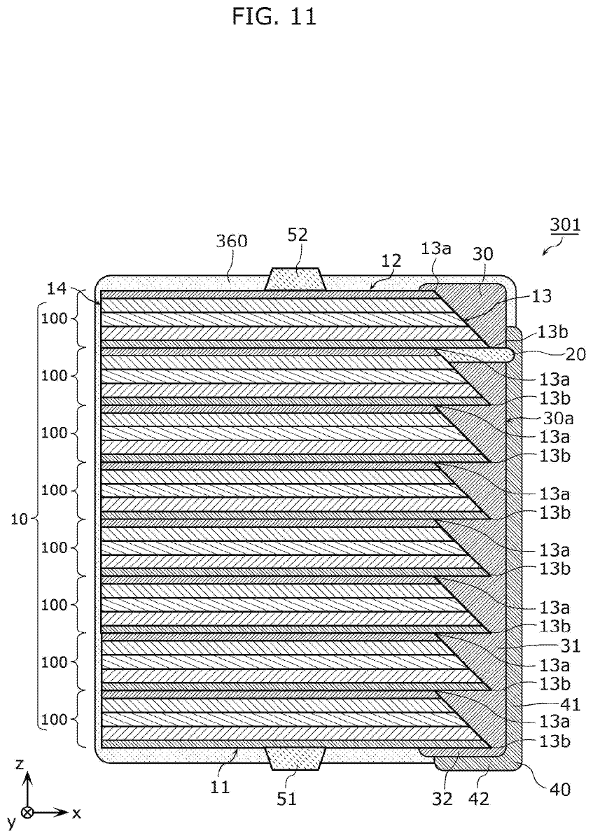

FIG. 11 is a cross-sectional view showing a cross-sectional configuration of battery 301 according to the present embodiment. As shown in FIG. 11, battery 301 further includes sealing member 360 in addition to the configuration of battery 1 according to Embodiment 1.

Sealing member 360 exposes parts of extraction electrodes 40 and seals power generation element 10. Sealing member 360 also exposes electrode terminals 51 and 52. For example, sealing member 360 is provided to prevent power generation element 10 and insulating member 30 from being exposed.

Sealing member 360 is formed using an insulating material which is electrically insulating. Although as the insulating material, for example, a material for the sealing member of a generally known battery such as a sealant can be used. As the insulating material, for example, a resin material can be used. The insulating material may be a material which is insulating and non-ionically conductive. For example, the insulating material may be at least one type of epoxy resin, acrylic resin, polyimide resin, or silsesquioxane.

Sealing member 360 may include a plurality of different insulating materials. For example, sealing member 360 may have a multilayer structure. The individual layers in the multilayer structure may be formed using different materials to have different properties.

Sealing member 360 may include a particulate metal oxide material. Examples of the metal oxide material which can be used include silicon oxide, aluminum oxide, titanium oxide, zinc oxide, cerium oxide, iron oxide, tungsten oxide, zirconium oxide, calcium oxide, zeolite, glass, and the like. For example, sealing member 360 may be formed using a resin material in which a plurality of particles of the metal oxide material are dispersed.

The particle size of the metal oxide material may be less than or equal to the distance between positive electrode current collector 121 and negative electrode current collector 111. Although examples of the particle shape of the metal oxide material include a spherical shape, an ellipsoidal shape, a rod shape, and the like, the present embodiment is not limited to these shapes.

Sealing member 360 is provided, and thus it is possible to enhance the reliability of battery 301 at various points such as mechanical strength, short-circuit prevention, and a moisture-proof property.

### Embodiment 4

Embodiment 4 will then be described.

Embodiment 4 differs from Embodiment 1 in that extraction electrodes have a multilayer structure. Differences from Embodiment 1 will be mainly described below, and the description of common points will be omitted or simplified.

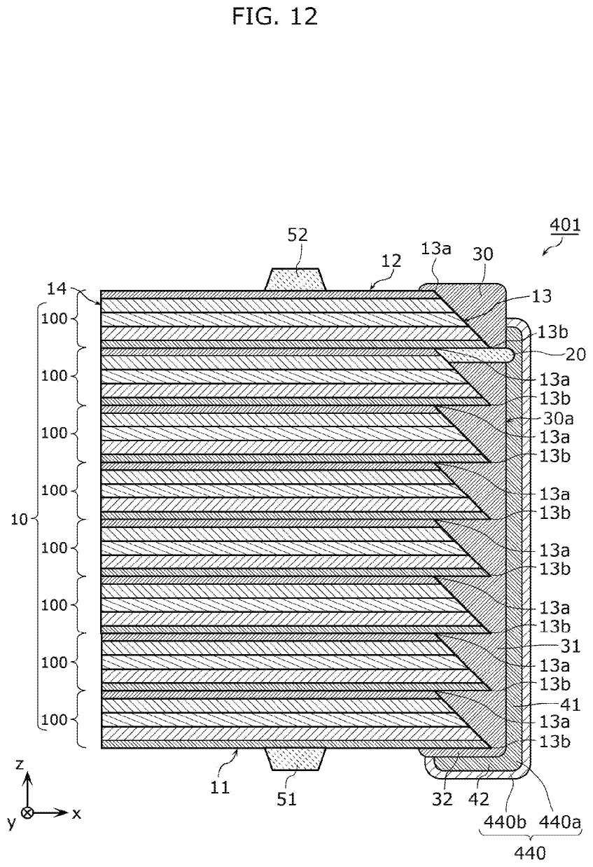

FIG. 12 is a cross-sectional view showing a cross-sectional configuration of battery 401 according to the present embodiment. As shown in FIG. 12, battery 401 differs from battery 1 according to Embodiment 1 in that battery 401 includes extraction electrodes 440 instead of extraction electrodes 40.

Extraction electrode 440 has a multilayer structure. Specifically, extraction electrode 440 includes first layer 440a and second layer 440b.

First layer 440a is the innermost layer in the multilayer structure, and is in contact with and covers conductive members 20 which are exposed from outer surface 30a of insulating member 30. For example, first layer 440a is formed using a conductive material which is in good contact with conductive members 20 or insulating member 30. For example, first layer 440a may have a higher gas barrier property than second layer 440b.

Second layer 440b is the outermost layer in the multilayer structure, and is exposed to the outside of battery 401. Second layer 440b is, for example, a plated layer or a solder layer. Second layer 440b is formed, for example, by a method such as plating, printing, or soldering. For example, second layer 440b may be more excellent in flexibility, impact resistance, or solder wettability than first layer 440a.

For example, a material suitable for mounting on a substrate is used to form second layer 440b, and thus the mountability of battery 401 can be enhanced.

Second layer 440b does not need to cover the entire outer surface of first layer 440a. Second layer 440b may cover only a part of first layer 440a. For example, when battery 401 is mounted on a substrate, second layer 440b may be formed on only the mounting part of the substrate. The number of layers included in extraction electrode 440 may be greater than or equal to three.

### Embodiment 5

Embodiment 5 will then be described.

Embodiment 5 differs from Embodiment 1 in the shapes of the conductive members, the extraction electrodes, and the electrode terminals. Differences from Embodiment 1 will be mainly described below, and the description of common points will be omitted or simplified.

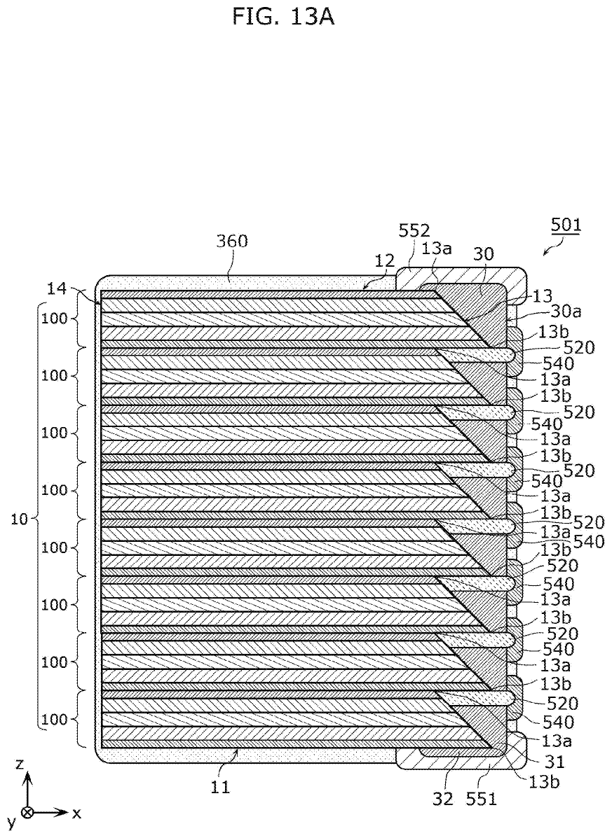

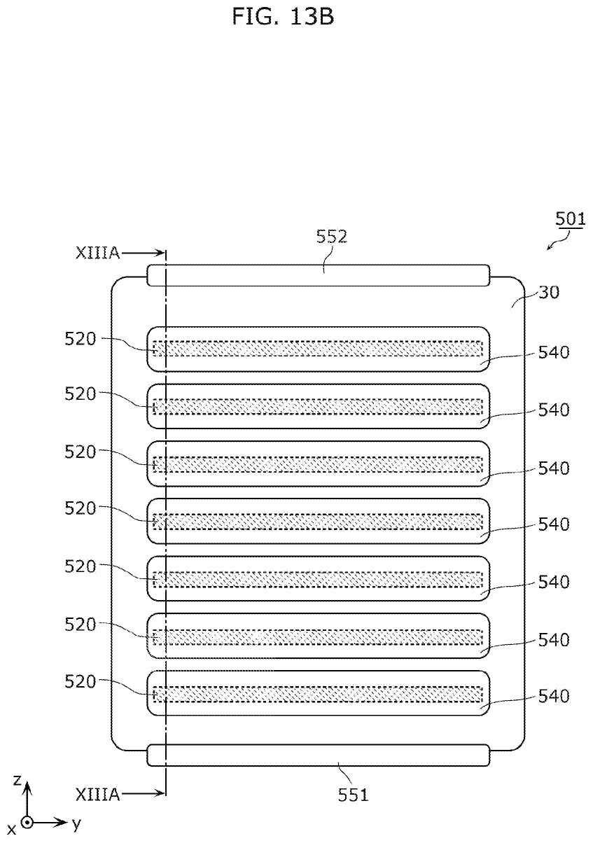

FIG. 13A is a cross-sectional view of battery 501 according to the present embodiment. FIG. 13B is a side view of battery 501 according to the present embodiment. Specifically, FIG. 13A shows a cross section taken along line XIIIA-XIIIA in FIG. 13B.

As shown in FIGS. 13A and 13B, battery 501 differs from battery 1 according to Embodiment 1 in that battery 501 includes a plurality of conductive members 520, a plurality of extraction electrodes 540, and electrode terminals 551 and 552 instead of conductive members 20, extraction electrodes 40, and electrode terminals 51 and 52. Battery 501 includes sealing member 360 as with battery 301 according to Embodiment 3.

As shown in FIG. 13B, each of conductive members 520 is in an elongated shape which extends along a direction (specifically, the direction of the y-axis) orthogonal to the direction normal to the main surface. In the present embodiment, conductive members 520 have the same shape and size. When conductive members 520 are viewed in the direction of the z-axis, conductive members 520 overlap each other. Battery 501 may include conductive members 20 instead of conductive members 520.

Each of extraction electrodes 540 is in an elongated shape which extends along a direction (specifically, the direction of the y-axis) orthogonal to the direction normal to the main surface. Each of extraction electrodes 540 is provided in a stripe shape which extends in the direction of the y-axis. Although extraction electrodes 540 have the same shape and size, extraction electrodes 540 may differ from each other in at least one of the shape or the size.

As shown in FIG. 13A, electrode terminal 551 is provided on main surface 11. Electrode terminal 551 extends on the side on which conductive members 520 and extraction electrodes 540 are provided. Specifically, electrode terminal 551 covers an end of outer surface 30a of insulating member 30.

Electrode terminal 552 is provided on main surface 12. Electrode terminal 552 extends on the side on which conductive members 520 and extraction electrodes 540 are provided. Specifically, electrode terminal 552 covers an end of outer surface of insulating member 30.

As shown in FIG. 13A, extraction electrodes 540 and electrode terminals 551 and 552 have the same height when outer surface 30a of insulating member 30 is a reference surface. The height here is the length in the direction of the x-axis. Hence, when battery 501 is mounted such that outer surface 30a faces a substrate, battery 501 is easily mounted on the substrate.

### Other Embodiments

Although the battery and the method for manufacturing a battery according to one or a plurality of aspects have been described above based on the embodiments, the present disclosure is not limited to these embodiments. Embodiments obtained by performing various types of variations conceived by a person skilled in the art on the present embodiment and embodiments established by combining constituent elements in different embodiments are also included in the scope of the present disclosure without departing from the spirit of the present disclosure.

For example, although in the embodiments described above, the example is shown where depressions 13a and projections 13b are provided only in side surface 13 of power generation element 10, the present disclosure is not limited to this example. The depressions and the projections may be provided in at least one of side surface 14, side surface 15, or side surface 16 of power generation element 10. In this case, the conductive members and the extraction electrodes are provided in two or more different side surfaces of the battery.

For example, in two adjacent unit cells 100, negative electrode current collector 111 and positive electrode current collector 121 may be shared. Specifically, negative electrode active material layer 112 may be provided on one main surface of one current collector so as to be in contact with the one main surface, and positive electrode active material layer 122 may be provided on the other main surface so as to be in contact with the other main surface.

Insulating member 30 may include air gaps. The air gap is a space in which a predetermined gas is sealed. Although the gas is, for example, dried air, the present embodiment is not limited to the dried air. The size and shape of the air gap are not particularly limited. The air gaps may be provided between insulating member and side surface 13 of power generation element 10. The air gaps may also be provided between insulating member 30 and extraction electrodes 40.

As described above, the air gaps are provided in insulating member 30, and thus stress relaxation for expansion and contraction associated with charging and discharging of battery 1, mechanical impact, and the like can be performed. In this way, the possibility that battery 1 is destroyed is reduced, and thus reliability can be enhanced.

For example, when protrusion portions 113 or protrusion portions 123 are viewed in the direction of the z-axis, they do not need to overlap each other. For example, when power generation element 10 includes four unit cells 100, different protrusion portions 123 may be provided in respective side surfaces of power generation element 10. In this way, all the directions of extraction of the intermediate voltage can be made different, and thus the occurrence of a short circuit can be suppressed.

For example, although in the embodiments described above, the examples are shown where extraction electrodes 40, 440, and 540 are in contact with outer surface 30a of insulating member 30, the present disclosure is not limited to these examples. Extraction electrodes 40, 440, and 540 may be provided along outer surface 30a. For example, extraction electrodes 40, 440, and 540 may be provided parallel to outer surface 30a, and gaps may be provided between outer surface 30a and extraction electrodes 40, 440, and 540. Other members may be arranged between extraction electrodes 40, 440, and 540 and outer surface 30a.

In the embodiments described above, various changes, replacement, addition, omission, and the like can be performed in the scope of claims or a scope equivalent thereto.

### INDUSTRIAL APPLICABILITY

The present disclosure can be utilized, for example, as batteries for electronic devices, electrical apparatuses, electric vehicles, and the like.

1. A battery comprising:
a power generation element that includes a plurality of unit cells each including a positive electrode layer, a negative electrode layer, and a solid electrolyte layer located between the positive electrode layer and the negative electrode layer,
wherein the plurality of unit cells are electrically connected in series and are stacked in a direction normal to a main surface of the power generation element,
the power generation element includes a side surface,
in the side surface, one electrode layer of the positive electrode layer and the negative electrode layer in each of the plurality of unit cells protrudes more than an other electrode layer such that depressions and projections arranged alternately in the direction normal to the main surface are provided,
each of the depressions includes a first inclination surface that is inclined relative to the direction normal to the main surface and is an end surface of the other electrode layer, and
the battery further comprises:
one or more conductive members each provided for and in contact with a corresponding one of the projections;
an insulating member that covers the side surface to expose at least a part of each of the one or more conductive members; and
one or more extraction electrodes that are in contact with the one or more conductive members exposed from an outer surface of the insulating member and are arranged along the outer surface of the insulating member.

2. The battery according to claim 1,
wherein each of the one or more conductive members is in contact with a main surface of the one electrode layer in the corresponding one of the projections.

3. The battery according to claim 1,
wherein the one or more conductive members comprise a plurality of conductive members,
the one or more extraction electrodes comprise a plurality of extraction electrodes, and
the plurality of conductive members do not overlap each other when viewed in the direction normal to the main surface.

4. The battery according to claim 3,
wherein each of the plurality of extraction electrodes includes a side surface cover portion that extends along the direction normal to the main surface and is in an elongated shape.

5. The battery according to claim 4,
wherein the insulating member continuously covers from the side surface to an end of a main surface of the power generation element, and
each of the plurality of extraction electrodes further includes an end cover portion that is continuous from the side surface cover portion and overlaps the insulating member when the main surface of the power generation element is viewed in plan view.

6. The battery according to claim 5, further comprising:
an electrode terminal that is provided on the main surface of the power generation element,
wherein the end cover portion of each of the plurality of extraction electrodes and the electrode terminal have a same height when the main surface of the power generation element is a reference surface.

7. The battery according to claim 1,
wherein each of the one or more extraction electrodes is in an elongated shape that extends along a direction orthogonal to the direction normal to the main surface.

8. The battery according to claim 7, further comprising:
an electrode terminal that is provided on each of two main surfaces of the power generation element,
wherein two electrode terminals each being the electrode terminal and the one or more extraction electrodes have a same height when the side surface is a reference surface.

9. The battery according to claim 1,
wherein each of the projections includes a second inclination surface that is inclined relative to the direction normal to the main surface and is at least a part of an end surface of the one electrode layer.

10. The battery according to claim 9,
wherein the first inclination surface, the second inclination surface, and a part of an end surface of the solid electrolyte layer are flush with each other.

11. The battery according to claim 1,
wherein exposed parts of the one or more conductive members and the insulating member are flush with each other.

12. The battery according to claim 1,
wherein the positive electrode layer in the unit cell includes:
a positive electrode current collector; and
a positive electrode active material layer that is arranged on a main surface of the positive electrode current collector on a side of the negative electrode layer, and
the negative electrode layer in the unit cell includes:
a negative electrode current collector; and
a negative electrode active material layer that is arranged on a main surface of the negative electrode current collector on a side of the positive electrode layer.

13. The battery according to claim 1,
wherein the one or more extraction electrodes are in contact with the outer surface of the insulating member.

14. The battery according to claim 1,
wherein each of the one or more extraction electrodes includes a multilayer structure.

15. The battery according to claim 14,
wherein an outermost layer in the multilayer structure is a plated layer or a solder layer.

16. The battery according to claim 1, further comprising:
a sealing member that exposes a part of each of the one or more extraction electrodes and seals the power generation element.

17. A method for manufacturing a battery, the method comprising:
preparing a plurality of unit cells each including a positive electrode layer, a negative electrode layer, and a solid electrolyte layer located between the positive electrode layer and the negative electrode layer,
wherein in each of the plurality of unit cells, an inclination surface that is inclined relative to a direction normal to a main surface is provided in an end surface of an other electrode layer of the positive electrode layer and the negative electrode layer such that one electrode layer of the positive electrode layer and the negative electrode layer protrudes more than the other electrode layer, and
the method for manufacturing a battery further comprises:
stacking the plurality of unit cells in the direction normal to the main surface by causing the positive electrode layer and the negative electrode layer to face each other;
arranging, for respective one electrode layers each being the one electrode layer, one or more conductive members that make contact with protruding parts of the one electrode layers;
arranging an insulating member to expose at least a part of the one or more conductive members; and
arranging one or more extraction electrodes that correspond to the respective one or more conductive members and make contact with the one or more conductive members exposed from an outer surface of the insulating member and the outer surface of the insulating member.

18. The method for manufacturing a battery according to claim 17,
wherein the arranging of the one or more conductive members is performed after the stacking.

19. The method for manufacturing a battery according to claim 17,
wherein the stacking is performed after the arranging of the one or more conductive members.

20. The method for manufacturing a battery according to claim 17,
wherein in the preparing, the end surface of the other electrode layer of each of the plurality of unit cells is processed to prepare the plurality of unit cells in which the inclination surface is provided.

21. The method for manufacturing a battery according to claim 20,
wherein the processing in the preparing is performed by shear cutting, score cutting, razor cutting, ultrasonic cutting, laser cutting, jet cutting, or polishing.

22. The method for manufacturing a battery according to claim 20,
wherein in the processing in the preparing, an end surface of the negative electrode layer, an end surface of the solid electrolyte layer, and an end surface of the positive electrode layer are collectively inclined obliquely relative to the direction normal to the main surface.

23. The method for manufacturing a battery according to claim 17, further comprising:
flattening exposed parts of the one or more conductive members and the insulating member before the arranging of the one or more extraction electrodes is performed after the arranging of the insulating member has been performed.
